(19) United States
(12) Patent Application Publication
(10) Pub. No.: US 2018/0034324 A1
(43) Pub. Date: Feb. 1, 2018

(54) INDUCTIVE POWER RECEIVER

(71) Applicant: PowerbyProxi Limited, Freemans Bay, Auckland (NZ)

(72) Inventor: Ali ABDOLKHANI, Freemans Bay, Auckland (NZ)

(73) Assignee: PowerbyProxi Limited, Freemans Bay, Auckland (NL)

(21) Appl. No.: 15/550,487

(22) PCT Filed: Feb. 11, 2016
(86) PCT No.: PCT/NZ2016/050012

§ 371 Date: Aug. 11, 2017

Related U.S. Application Data
(60) Provisional application No. 62/115,734, filed on Feb. 13, 2015.

(51) Int. Cl. H02J 50/12; H02M 3/335; H01F 38/14; H04B 5/00

(52) U.S. Cl. CPC H02J 50/12; H04B 5/0037; H02M 3/33576; H01F 38/14; H04B 5/0075; H04B 5/0093; H02M 3/33592

(57) ABSTRACT

An inductive power receiver having a power pick-up stage and a power rectification and regulation stage consisting of a single current control element configured to rectify the voltage from the power pick-up stage in a first half cycle and to regulate the voltage from the power pick-up stage in a second half cycle.

### FIELD

This invention relates generally to a converter, particularly though not solely, to a converter for an inductive power receiver.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

However currently available inductive power receivers may still suffer from having large component counts, and/or large component foot prints. Accordingly, the present invention may provide an improved inductive power receiver or may provide the public with a useful choice.

### SUMMARY

According to an example embodiment there is provided an inductive power receiver comprising:
a power pick-up stage; and
a power rectification and regulation stage consisting of a single current control element configured to rectify the voltage from the power pick-up stage in a first half cycle and to regulate the voltage from the power pick-up stage in a second half cycle.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a block diagram of an example receiver;

FIG. 3 is a simplified circuit diagram of an example inductive power receiver;

FIG. 4 is a circuit diagram of an example inductive power receiver; and

FIG. 5 is a graph of a timing diagram from an example inductive power receiver.

### DETAILED DESCRIPTION

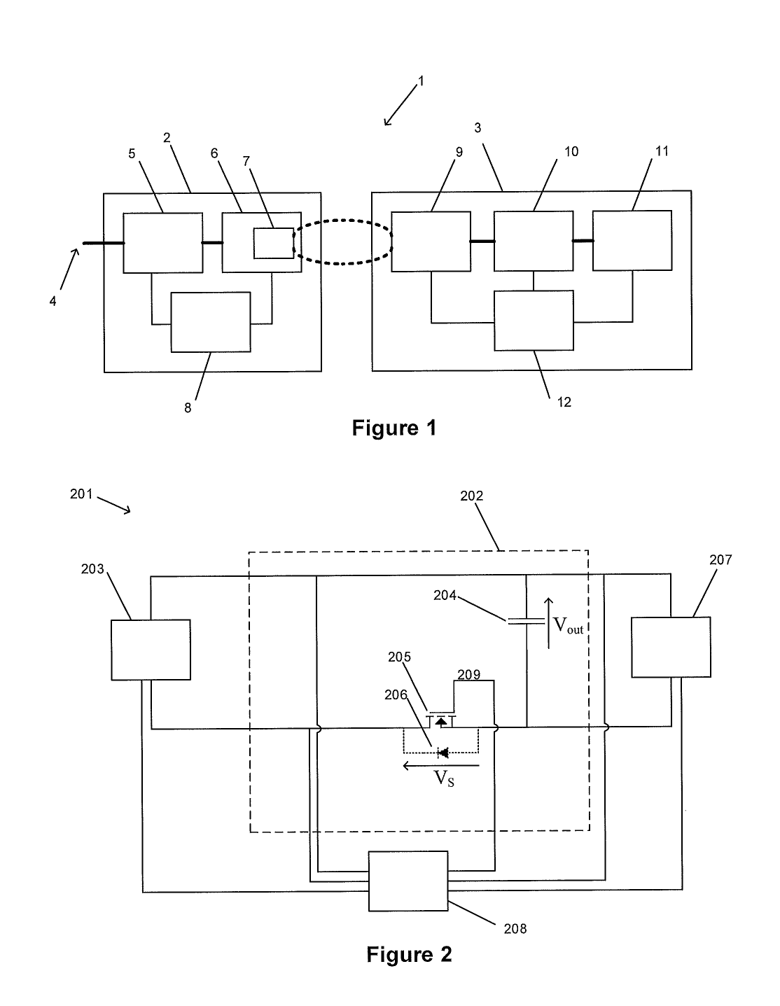

An inductive power transfer (IPT) system 1 is shown generally in FIG. 1.

The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil or coils 7 may be separate from the inverter 6. The transmitting coil or coils 7 may be connected to capacitors (not shown) either in parallel or series to create a resonant circuit.

A controller 8 is provided to control operation of the inductive power transmitter 2 and may be directly or indirectly connected to several or all parts of the transmitter 2. The controller 8 receives inputs from the various operational components of the inductive power transmitter 2 and produces outputs that control that operation. The controller 8 may be implemented as a single unit or separate units, configured to control various aspects of the inductive power transmitter 2 depending on its capabilities, including for example: power flow, tuning, selectively energising transmitting coil or coils 7, inductive power receiver detection and/or communications.

The inductive power receiver 3 includes a power pick-up stage 9 connected to power conditioning circuitry 10 that in turn supplies power to a load 11. The load may be an electrically operational part of an electronic device or machine, or may be one or more power storage elements. The power pick-up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors and additional inductors (not shown) either in parallel, series or some other combination, such as inductor-capacitor-inductor, to create a resonant circuit. In some inductive power receivers, the receiver may include a controller 12 which may control tuning of the receiving coil or coils, operation of the power conditioning circuitry 10, characteristics of the load 11 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

Current induced in the power pick-up stage 9 by transmitting coil or coils 7 will typically be high frequency AC at the frequency of operation of the transmitting coil or coils 7, which may be for example, 20 kHz, up to hundreds of megahertz or higher. The power conditioning circuitry 10 is configured to convert the induced current into a form that is appropriate for powering or charging the load 11, and may perform for example power rectification, power regulation, or a combination of both.

FIG. 2 shows a block diagram of an inductive power receiver, according to an example embodiment. Example inductive power receiver 201 has example power conditioning circuitry 202 which performs the combined functions of power rectification and power regulation at different parts of the period of each AC cycle as generated at a power pick-up stage 203. As illustrated, the power conditioning circuitry 202 has a DC output capacitor 204 and a current control element, illustrated as a switch device (MOSFET) 205 and associated (body) diode 206, which is operated so that the signal received by the power pick-up stage 203 is rectified/regulated using the current control element and is output to a load 207 via the DC output capacitor 204.

During a first part-cycle, which can be referred to as the “rectification part-cycle” and which may be approximately a half period in duration, the voltage generated by power pick-up stage 203 is greater than Vₒᵤₜ, which is the voltage appearing across DC output capacitor 204. This means that V_{S}, the voltage appearing across MOSFET 205 and its body diode 206, is negative. As such, current flows through the parallel combination of MOSFET 205 and body diode 206 and through to the power pick-up stage 203. To complete the circuit, current also flows from the power pick-up stage 203 to load 207 and DC output capacitor 204, which are connected in parallel.

During a second part-cycle, which can be referred to as the “regulation part-cycle” and which may be approximately a half period in duration, the voltage generated by power pick-up stage 203 is less than Vₒᵤₜ, the voltage present on DC output capacitor 204. Therefore, the voltage V_{S}, appearing across MOSFET 205 and its body diode 206, is positive. If MOSFET 205 is configured, by controller 208, to be on, using MOSFET gate 209, for at least some of this regulation part-cycle, current will flow through MOSFET 205. To complete the circuit, current will also then flow from DC output capacitor 204 to power pick-up stage 203. By controlling

MOSFET 205 during this second part-cycle, the amount of power that is allowed to flow back from DC output capacitor 204 to power pick-up stage 203 can be adjusted.

Based on the descriptions of the rectification part-cycle and the regulation part-cycle given in the preceding paragraphs it is apparent that the net flow of current from the power pick-up stage 203 to DC load 207 can be controlled. Therefore, the DC output voltage can be regulated, for a variety of loading conditions and for a range of voltages received by the pick-up coil or coils (not shown) in power pick-up stage 203. In this way, half-wave rectification, as well as output voltage regulation, may be achieved by example power conditioning circuitry 202. Combining regulation and rectification in this way reduces the component count in the receiver, which may allow for a smaller footprint, reduce the total cost of the target device, improve efficiency and/or reduce heat generation due to reduced power losses in the componentry.

A variety of alternative forms of the example power conditioning circuitry of FIG. 2 may be possible, by using different current control elements. In general, a current control element should be capable of selectively blocking and unblocking the flow of current between DC output capacitor 204 and power pick-up stage 203.

For example, a simple variation to example inductive power receiver 201 of FIG. 2 which may yield performance improvements is to supplement body diode 206 of MOSFET 205 with a separate external diode in parallel, to lower diode losses.

A number of alternative switch type current control elements may be used in example power conditioning circuitry 202 of FIG. 2. In some cases, changing to a different switch type may require a modification to the circuit topology shown, for example, in order to drive the switch in a simple manner. Possible switch device types include, but are not limited to, field effect transistors (FETs), bipolar junction transistors (BJTs) and insulated gate bipolar transistors (IGBTs). Depending on switch driving requirements and position within the circuit, either P or N type devices can be used, or a combination of both.

The circuit topology for power pick-up stage 203 in FIG. 2, for use with example power conditioning circuitry 202 and its variations, is selected to provide a low impedance path for DC through its terminals. Because a half-wave rectifier is used in example power conditioning circuit 202, any DC current passing through load 207 and DC output capacitor 204 must also pass through power pick-up stage 203. Since DC output capacitor 204 represents an open circuit at DC frequencies, the DC current through load 207 must be the same as the DC current through power pick-up stage 203, in the steady state, and this value cannot be zero for most useful cases, as this would result in zero DC output current at load 207.

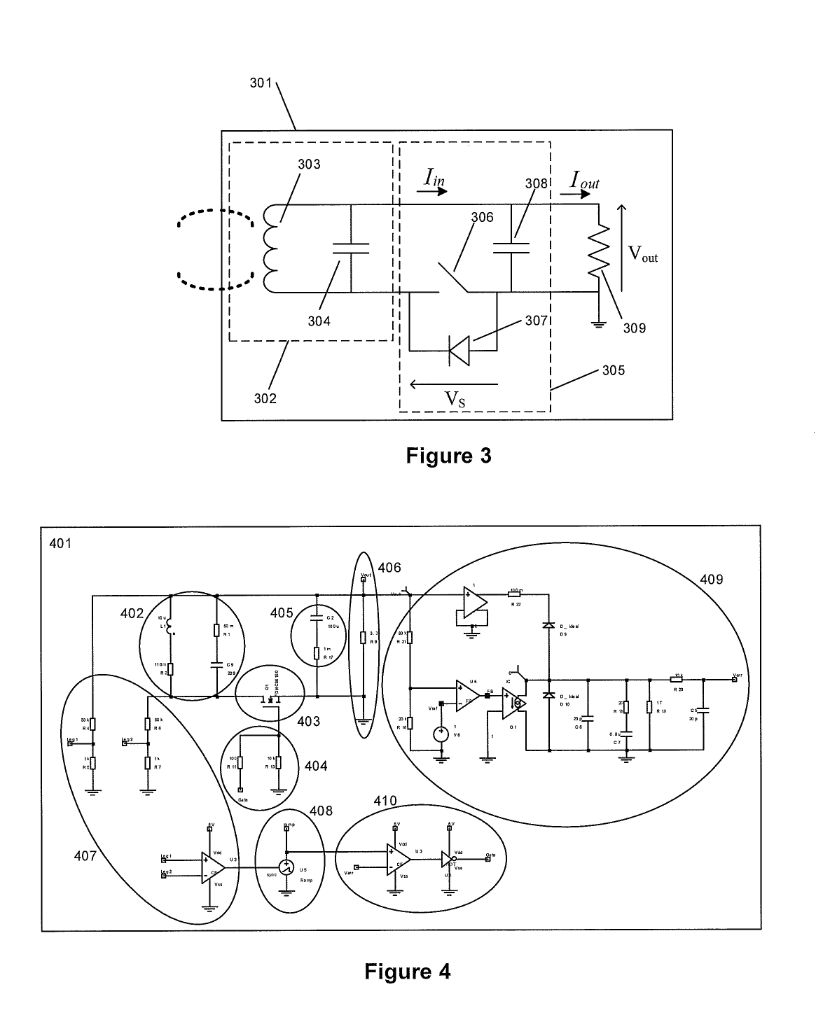

FIG. 3 shows a simplified circuit diagram of an example inductive power receiver 301. The example inductive power receiver 301 has a parallel connected L-C power pick-up stage 302 having a pick-up coil 303 connected in parallel to a tuning capacitor 304. The capacitance value of tuning capacitor 304 is such that it is tuned for resonance with pick-up coil 303 at or near to the operating frequency of the coupling transmitter. Alternatively, tuning capacitor 304 may be chosen such that it is either larger or smaller than a resonantly tuned value, in order to increase the power gathering capacity of the power pick-up stage, to make parallel connected L-C power pick-up stage 302 more robust to component value or operating frequency variations or to make it easier to de-tune, reduce system size and cost, etc. This rationale may also be applied to the component values used when tuning other types of power pick-up stages, in addition to the parallel connected L-C power pick-up stage 302 which is shown in FIG. 3.

The example inductive power receiver 301 further has example power conditioning circuitry 305 which has a current control element, illustrated as a switch 306 and associated diode 307, which functions in similar fashion to the afore-described example power conditioning circuitry. Typically in inductive power transfer systems with parallel tuned power pick-up stages, a second inductor will be used in addition to the pick-up inductor, in order to maintain a more constant current flow out of the parallel tuned tank, or otherwise in some way avoid exposing the parallel tuned tank to non-linear loading. This extra inductor is typically desirable because without it, non-linear load elements such as a bridge rectifier may inhibit the resonance of a parallel tuned power pick-up stage. By reducing this non-linearity, an additional inductance can help to increase the quality factor of the resonance of the LC tank and can therefore help increase the power output and efficiency of the system.

However, in the case of the circuit shown in FIG. 3, a large value DC inductor in series with parallel connected L-C power pick-up stage 302 is not necessarily useful because, in some cases, forcing DC current to flow through example power conditioning circuitry 305, and therefore through switch 306, for a greater part or all of the operating period would make the regulation part-cycle shorter or non-existent, thus reducing the circuit's ability to regulate output voltage. Further, this additional DC inductor will often be a large and expensive part of an IPT receiver system. For these reasons, avoiding the use of a DC inductor may be particularly advantageous for certain types of power conditioning circuits such as example power conditioning circuitry 305 of FIG. 3.

Referring once again to FIG. 2, a range of control methods are available for MOSFET 205 in example power conditioning circuitry 202. The switch control method used may depend on a variety of factors including load conditions, magnetic coupling strength of the power pick-up stage, switch type and layout, and the type of power pick-up stage used. For any one configuration there may be more than one possible switch control method, and the method selected may change during operation.

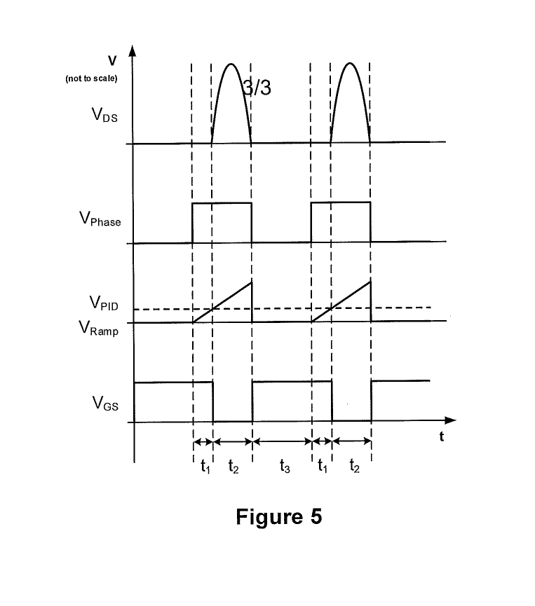

A first switch control method will be illustrated using example inductive power receiver 301 of FIG. 3. Switch 306 of FIG. 3 starts the rectification part-cycle in an off state. At this time, V_{S} is negative and current is flowing through diode 307. At some point during the rectification part-cycle, switch 306 is turned on by a controller. Because V_{S} is still negative, current will continue to flow through diode 307, and/or through the switch itself, depending on the relative on-resistances of the switch 306 and diode 307. During this time, the voltage across parallel connected L-C power pick-up stage 302, including pick-up coil 303 and parallel tuning capacitor 304, will decrease, eventually reaching the point where V_{S} becomes positive. This change of polarity indicates the end of the rectification part-cycle and the start of the regulation part-cycle, and is the beginning of period t₁ in FIG. 5. Because switch 306 is already turned on from the rectification part-cycle, current is able to flow back from DC output capacitor 308 to parallel connected L-C power pick-up stage 302, releasing some of the stored charge in DC output capacitor 308 to return to parallel connected L-C power pick-up stage 302. After waiting a period of time, t₁ in FIG. 5, which should be less than or equal to the length of the regulation part-cycle, switch 306 is turned off by the controller, at the end of period t₁. At this point, period t₂ of FIG. 5 begins. The voltage across the parallel connected L-C power pick-up stage 302 will continue to rise and the voltage V_{S} across switch 306 will rise and then fall again to become negative, marking the end of the regulation part-cycle and t₂ and the start of a new rectification part-cycle and t₃. Current will then begin to flow through diode 307.

At any point during the rectification part-cycle, the switch may be turned on again, thus allowing current to flow through the switch rather than just diode 307 and resetting the system to its initially described state, ready for the start of the next regulation cycle. By making waiting period t₁ shorter, output voltage Vₒᵤₜ will increase, as less current is allowed to flow back from DC output capacitor 308 to parallel connected L-C power pick-up stage 302. Conversely, by making t₁ longer, output voltage Vₒᵤₜ will decrease. A proportional integral (PI) or similar controller can be applied to ensure the desired output voltage set-point is reached. This switch control method has the advantage of zero voltage switch on and quasi zero voltage switch off, which helps to minimize switching losses.

A second switch control method will be illustrated using example inductive power receiver 201 of FIG. 2. Switch 206 starts the rectification part-cycle in an off state. However, in contrast with the preceding method, in this method, before the start of the regulation period, the controller 208 sets the state of switch 205 as either off or on and maintains this state throughout the regulation period. Controller 208 then decides the state of switch 205 for the following regulation period and changes the state of switch 205 as required. A hysteretic controller, PI controller or other controller type can be used to decide the state of switch 205 for each cycle, in order to reach the desired output voltage Vₒᵤₜ. Compared with the first method, this switching approach has the advantages that it does not require such a fast or accurate phase reference, does not require such fast or accurate switching, may reduce switching frequency and attendant losses, and helps to reduce high frequency emissions. However, output voltage ripple may be greater, other things being equal.

In a third switch control method, MOSFET 205 of FIG. 2 is switched on and off continuously without maintaining a fixed phase relationship with the AC current coming from power pick-up stage 203. MOSFET 205 may change state multiple times during the regulation period with preferably a certain duty cycle and a fixed frequency, the switching frequency generally being different from the operating frequency of the wireless power transmitting coil or coils 7. By varying the duty cycle of the MOSFET 205, control of output voltage Vₒᵤₜ may be achieved and a phase reference signal is not required. A small amount of DC inductance in series with MOSFET 205, as well as snubbing means in parallel with MOSFET 205 may be required to limit peak currents and voltages that MOSFET 205 is exposed to. Soft switching benefits may be lost using this switch control method.

In a fourth switch control method, the controller 208 of FIG. 2 starts the regulation cycle with the MOSFET 205 in an off state, and transitions to an on state during the regulation part-cycle. MOSFET 205 stays in an on state until the regulation cycle, during which it may be turned off again. This method is of particular use when power pick-up stages 203 appears to MOSFET 205 as an inductive load, such as when an un-tuned pick-up coil or an L-C-L tuned pick-up coil is used. This switching method allows the MOSFET 205 to avoid interrupting inductor current which flows in series with MOSFET 205, and therefore this approach avoids exposing MOSFET 205 to a voltage spike and additional switching loses which would result from interrupting this inductor current.

A further variation, which can be can be applied to any of the switch control methods described, involves synchronous rectification during the rectification part-cycle. By sensing when the rectification part cycle has started, MOSFET 205 may be turned on so that current, rather than flowing through the body diode 206, is able to flow through MOSFET 205 itself, allowing for a lower voltage drop across MOSFET 205 and lower losses. When controller 208 determines, on the basis of waiting for an elapsed period, a phase sense signal or by some other means, that the rectification part-cycle is nearing an end, MOSFET 205 can be then set to the required state for the start of the upcoming regulation period. In this way, the total power loss on MOSFET 205 and body diode 206 may be minimized.

Adaptions of the switching methods described herein may be beneficial or required in cases where different power pick-up stages or power conditioning circuitry are used. It is understood by a person skilled in the art as to how the switching methods given can be adapted to work with these different hardware variants.

In some switch control embodiments, it is necessary to measure the phase of some aspect of the system in order to determine when to drive the switch on or off. For example, with the first switch control method, voltage phase information may be used to determine or estimate when the rectification and regulation part-cycles begin and end. This is illustrated with reference to FIG. 4. FIG. 4 shows a circuit diagram of an example inductive power receiver 401 having parallel connected L-C power pick-up stage 402, MOSFET 403, gate drive resistors 404, DC output capacitor 405, load 406, phase sensing circuitry 407, ramp generator 408, PID controller 409 and gate drive logic 410.

In FIG. 4, phase sense circuitry 407 compares the voltage present across the terminals of parallel connected L-C power pick-up stage 402. When this voltage changes from negative to positive, ramp generator 408 is triggered and the voltage on its output begins to rise. This rising voltage is compared by gate drive logic 410 with the control effort value generated by PID controller 409. When the voltage output from ramp generator 408 rises to be equal to the control effort value produced by PID controller 409, the output of gate drive logic 410 changes state and MOSFET 403 is turned off via gate drive resistors 404.

While one voltage comparison phase sense technique has been described here, it will be apparent to those skilled in the art that a variety of different phase sensing techniques are known within the field of wireless or inductive power transfer. Many of these techniques could be applied to this circuit and to the related circuits described within this application, including but not limited to: zero voltage crossings, zero current crossings, the use of current sense transformers or resistors, use of an uncoupled phase sensing pick-up and use of a radio communications channel. In addition, while a purely hardware controller approach is taken in this example, it will be obvious to those skilled in the art that other controllers such as microcontrollers, FPGAs, CPLDs, ASICs or other types of controller could also be used. Further, it may be possible to integrate significant parts of the entire wireless receiver circuit onto a single integrated circuit, including phase and voltage sensing circuits, control circuitry, gate driving circuits and power switches.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver comprising:
a power pick-up stage; and
a power rectification and regulation stage consisting of a single current control element configured to rectify the voltage from the power pick-up stage in a first half cycle and to regulate the voltage from the power pick-up stage in a second half cycle.

2. The receiver in claim 1 wherein the power pick-up stage includes a receiver coil connected in parallel with a tuned resonant capacitor.

3. The receiver in claim 2 wherein the current control element is a switch.

4. The receiver in claim 2 wherein the current control element is a single MOSFET or two back to back MOSFETs.

5. The receiver in claim 1 wherein the current control element is configured to pass power to a load during the first half cycle and from the load during the second half cycle.

6. The inductive power receiver in claim 1 wherein the power pick-up stage is connected to the power rectification and regulation stage without a DC inductor.
